(19) United States
(12) Patent Application Publication
(10) Pub. No.: US 2012/0258674 A1
(43) Pub. Date: Oct. 11, 2012

(54) SESSION MANAGER AND SOURCE INTERNET PROTOCOL (IP) ADDRESS SELECTION

(75) Inventors: Catherine Livet, Montreal (CA); Alexander Reznik, Titusville, NJ (US); Michelle Perras, Montreal (CA)

(73) Assignee: INTERDIGITAL PATENT HOLDINGS, INC., Wilmington, DE (US)

(21) Appl. No.: 13/443,985

(22) Filed: Apr. 11, 2012

Related U.S. Application Data
(60) Provisional application No. 61/473,963, filed on Apr. 11, 2011.

(51) Int. Cl. H04B 1/38; H04W 76/00

(52) U.S. Cl. 455/73

(57) ABSTRACT

Embodiments contemplate one or more Session Manager and/or source IP address selection techniques. Embodiments contemplate that a session manager may establish a session in a wireless communication environment based on one or more policies specified by a policy manager. The session manager may also delete the session. For example, the session may be deleted in response to receipt of a request from an application. The session manager may store a session description for the session. The session manager may also perform source IP selection for a data plane. The session manager may also provide an MC transport with IP addresses for negotiating additional sub-flows.

### CROSS REFERENCE TO RELATED APPLICATIONS

This application claims the benefit of U.S. Provisional Application No. 61/473,963, titled “SESSION MANAGER AND SOURCE INTERNET PROTOCOL (IP) ADDRESS SELECTION”, filed on Apr. 11, 2011, the content of which being hereby incorporated by reference herein in its entirety, for all purposes.

### BACKGROUND

The Connection Manager (CM) may provide access connections so that users can connect to a network using predefined and static connections. The Connection Manager profiles can be used to connect to remote networks through servers, for example, again using predefined and static connections. The Connection Manager may also provide predetermined and static access connections for users to connect to applications.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments contemplate one or more Session managers (SM) and/or source Internet Protocol (IP) address selection techniques. Embodiments contemplate that a session manager may establish a session in a wireless communication environment based on one or more policies specified by a policy manager. In one or more embodiments, a session manager may also delete the session. For example, a session may be deleted in response to receipt of a request from an application. Embodiments also contemplate that a session manager may store a session description for the session. A session manager may also perform source IP selection for a data plane, for example. In addition, embodiments contemplate that a session manager may also provide a Multi-Connection (MC) transport with IP addresses for negotiating additional sub-flows, among other purposes.

Embodiments also contemplate a wireless transmit/receive unit (WTRU) that may comprise a processor. The processor may be configured, at least in part, to use at least one function to dynamically control one or more connection configurations based on, at least in part, one or more requirements of at least one of a WTRU user or one or more applications operating on the WTRU. Embodiments further contemplate that alternatively or additionally the processor may be further configured to use the at least one function to determine the use of one or more connections based, at least in part, on the one or more requirements. One or more embodiments contemplate that the one or more connections may be part of one or more respective sessions. Embodiments also contemplate that, alternatively or additionally, the processor may be further configured to use the at least one function based on one or more policies. One or more embodiments contemplate that the at least one function may operate in a control plane of the WTRU. Also, one or more embodiments contemplate that the at least one function may be a first function, and the first function may include one or more second functions.

Embodiments also contemplate that, alternatively or additionally, the processor may be further configured to use the at least one function to determine a service type for use by at least one of the one or more sessions. Alternatively or additionally, embodiments contemplate that the processor may be further configured to use the at least one function to determine a radio access technology (RAT) for use by at least one of the one or more sessions. Alternatively or additionally, embodiments contemplate that the processor may be further configured to use the at least one function to determine a priority of a first session of the one or more sessions relative to a second session of the one or more sessions.

Embodiments also contemplate, alternatively or additionally, that the processor may be further configured to use the at least one function to delete the second session of the one or more sessions upon determining that the first session of the one or more sessions is higher in priority than the second session. One or more embodiments contemplate that the at least one function may be a session manager function. Alternatively or additionally, embodiments contemplate that the processor may be configured to use the at least one function to determine that at least one of the one or more sessions is to be closed, and, to close the at least one of the one or more sessions.

Embodiments contemplate a wireless transmit/receive unit (WTRU) that may comprise a processor, where the processor may be configured, at least in part, to use at least one function to dynamically determine one or more source Internet Protocol (IP) addresses for one or more applications operating on the WTRU based, at least in part, on at least one of one or more policies or one or more quality of service (QoS) requirements. Alternatively or additionally, one or more embodiments contemplate that the one or more policies may include a correspondence between the one or more source IP addresses and one or more conditions.

Embodiments further contemplate, alternatively or additionally, that the one or more conditions may include at least one correspondence between the one or more source IP addresses and at least one of a type of application or an availability of a mobility support. One or more embodiments contemplate that the at least one function may be a session manager function. Alternatively or additionally, embodiments contemplate that the at least one function may utilize a getaddrinfo parameter. Embodiments also contemplate that the QoS requirements may include at least one of a preferred network for an application, a list of prohibited networks, a mobility requirement per application, or a bandwidth aggregation requirement.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and an example core network that may be used within the communications system illustrated in FIG. 1A;

FIG. 1E is a system diagram of another example radio access network and an example core network that may be used within the communications system illustrated in FIG. 1A;

FIG. 2 illustrates a block diagram of an example functional architecture for an EIPS and ACMS equipped terminal consistent with embodiments;

FIG. 3 illustrates a flow chart of an example session manager (SM) connection establishment process consistent with embodiments;

FIG. 4 illustrates a functional diagram of an example SM FC consistent with embodiments;

FIG. 5 illustrates an exemplary block diagram of a use of one or more functions consistent with embodiments;

FIG. 5A illustrates an exemplary block diagram of a use of one or more functions consistent with embodiments; and

FIG. 6 illustrates an exemplary block diagram of a use of one or more functions consistent with embodiments.

### DETAILED DESCRIPTION OF ILLUSTRATIVE EMBODIMENTS

A detailed description of illustrative embodiments will now be described with reference to the various Figures. Although this description provides a detailed example of possible implementations, it should be noted that the details are intended to be exemplary and in no way limit the scope of the application. As used herein, the article “a”, absent further qualification or characterization, may be understood to mean “one or more” or “at least one”, for example.

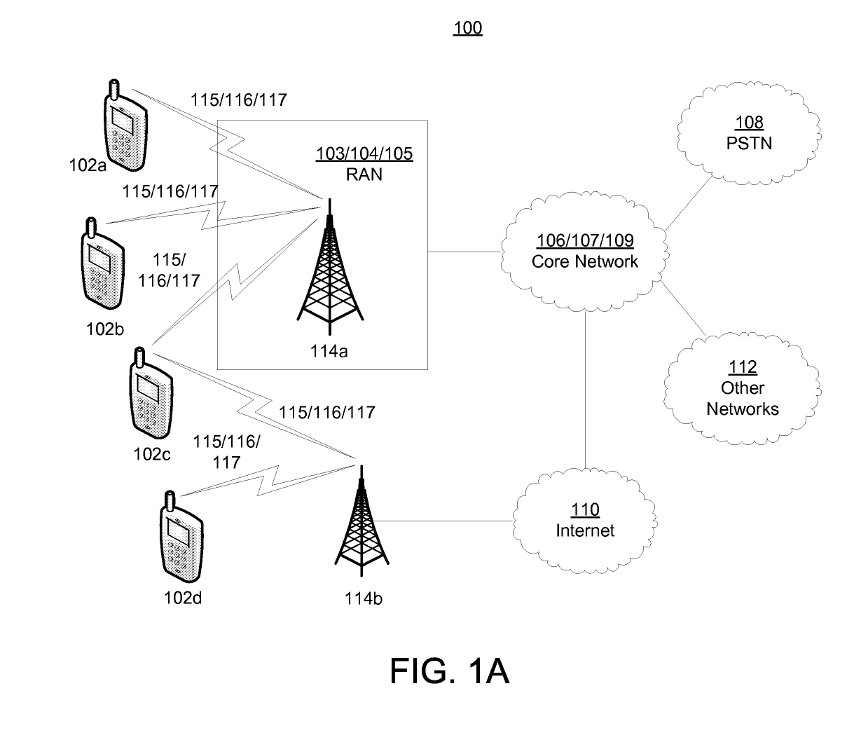

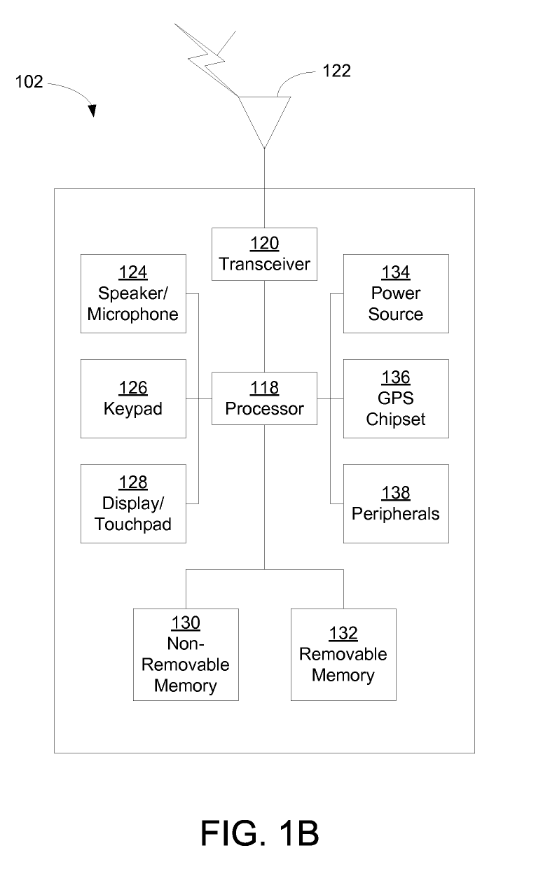

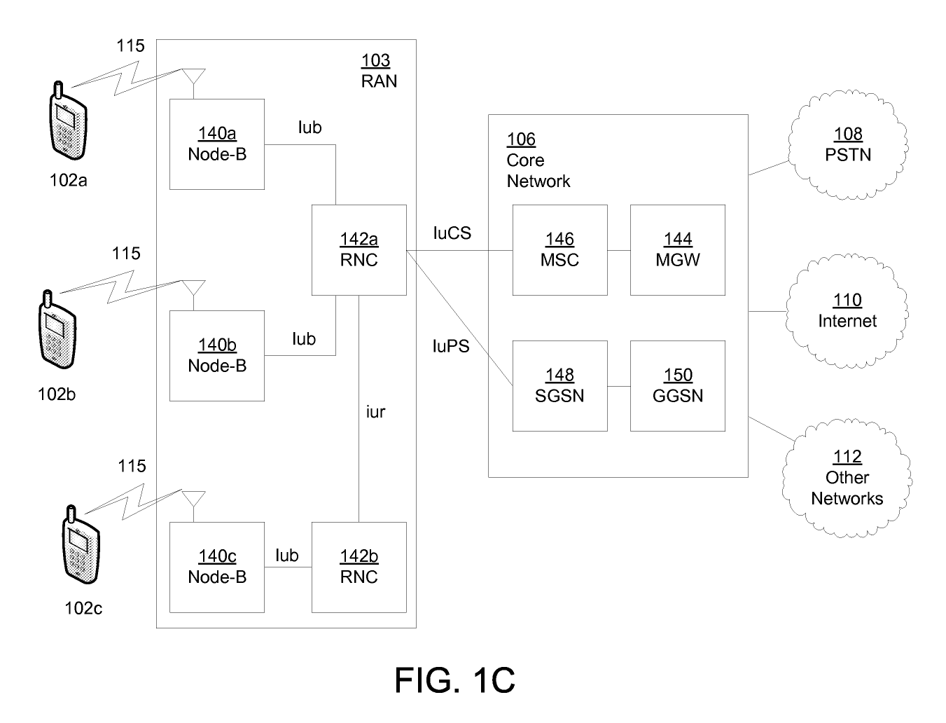

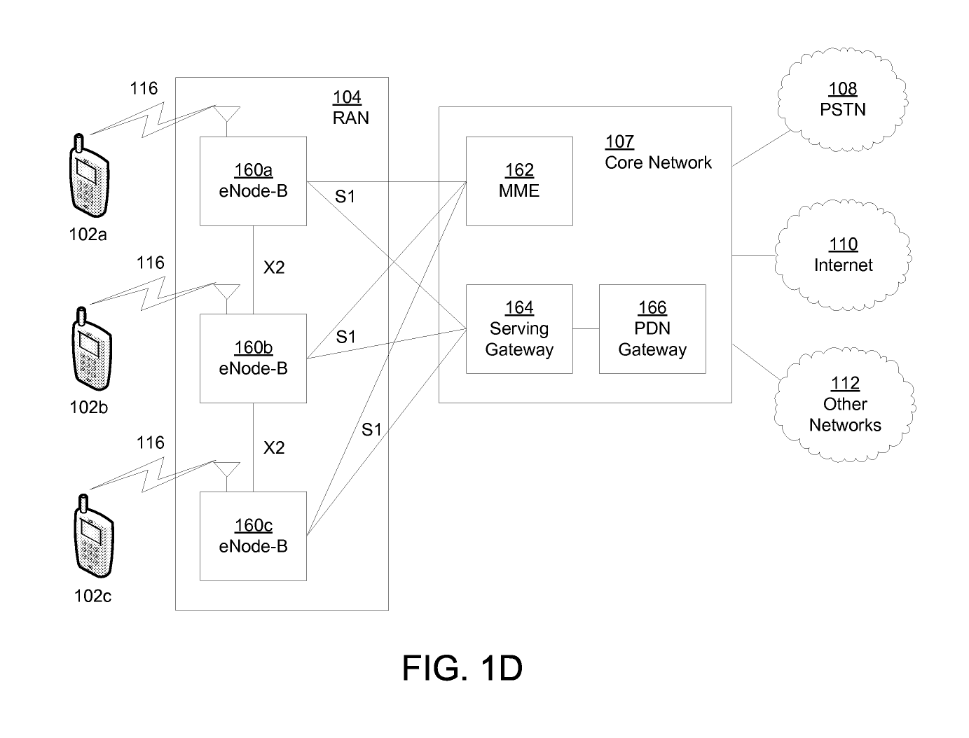

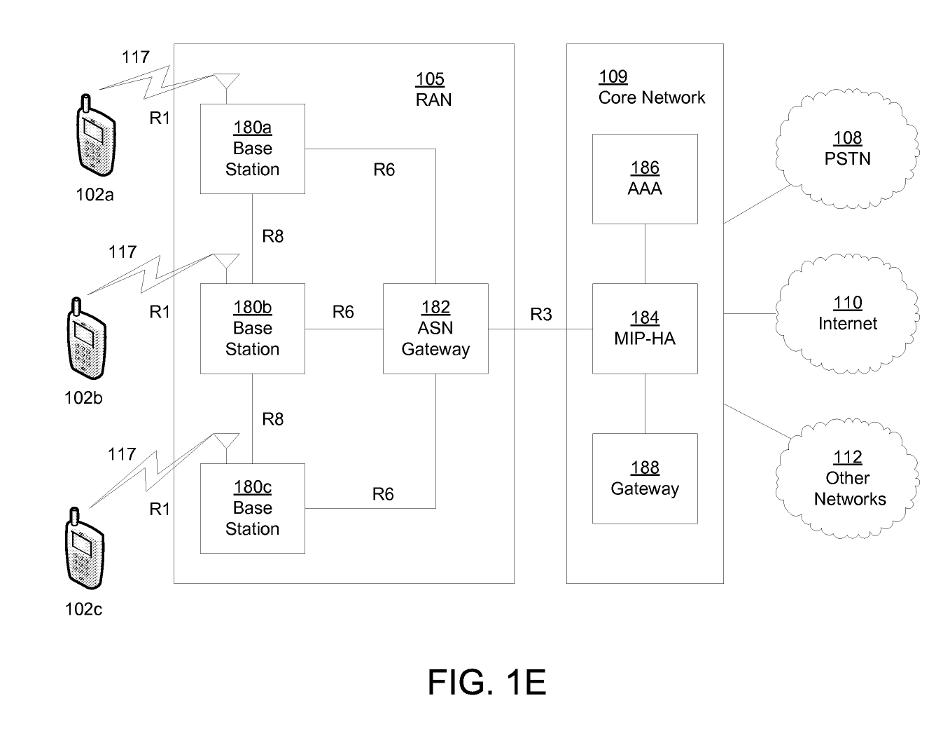

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Embodiments recognize that in a multi-homed device (e.g., a device which may support one or more, or multiple, wired and/or wireless interfaces) a connection manager (CM) may be a function that can make an interface between one or more applications and one or more low-layer interfaces. The connection manager may be responsible for establishing, maintaining, and/or releasing interfaces at the physical layer and may track which connections may be in use or may be requested by applications. Further, embodiments recognize that a connection manager may close unused connections and/or automatically disconnect connections when they are idle for a specified period of time, etc., for example.

In an example, the command Getaddrinfo( ) issued by one or more applications can return a list of local addresses to the one or more applications that may contain IPv6 and/or IPv4 addresses. Executing the command may be performed by the operating system (OS). Suitable algorithms may provide for the Source (Src) IP sorting, perhaps based on how close the Source IP address is from the given destination IP address, for example. Embodiments recognize that applicable rules may, however, be static and thus may not be adequate in many cases. In an example, Linux provides a way to configure the sorting algorithm configuration but may also not be adequate in many cases.

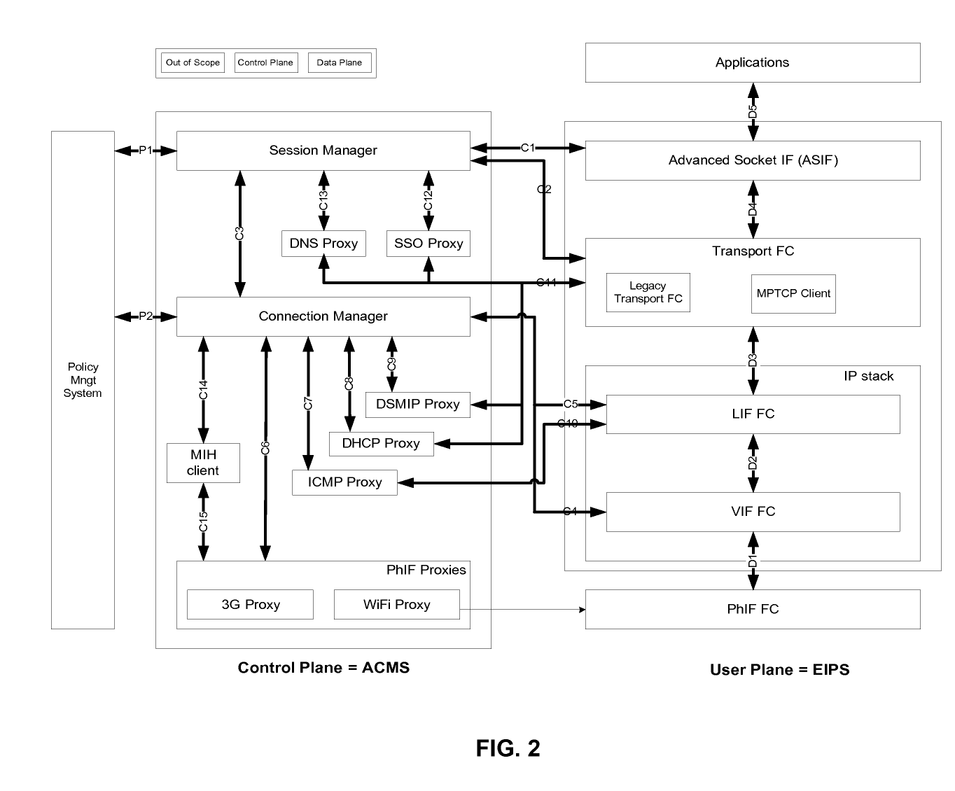

FIG. 2 illustrates a block diagram of an example functional architecture for an EIPS and ACMS equipped terminal. Referring to FIG. 2, the data plane components shown in the blocks labeled “Advanced Socket IF (ASIF),” “Transport Functional Component (Transport F C),” “LIF F C,” and “VIF FC” comprise the EIPS, while the control plane components shown in the blocks labeled “Session Manager,” DNS Proxy,” “SSO Proxy,” “Connection Manager,” “MIH client,” “DSMIP Proxy,” DHCP Proxy,” “ICMP Proxy,” “3G Proxy,” and “WiFi Proxy” comprise the ACMS. Certain terminal components are shown in the blocks labeled “Policy Management (Mngt) System,” “Applications,” and “PhIF FC.” Contemplated interfaces in the data plane are shown and described herein. Embodiments contemplate interfaces between one or more data plane components and control plane components as well as within the control plane. The interfaces applying to the data plane are named Dxx while the interfaces with the control plane are called Cxx and interfaces with policy management are called Pxx.

Embodiments contemplate that network selection can be controlled and/or monitored by the operator (e.g., 3GPP network) and/or by the user (e.g., in a café, where there is 3G and a hotspot wireless local area network (WLAN) coverage, the user might prefer to connect freely to the hotspot preferably to the 3G network). Applications can also have their own policies (e.g., even at home, a voice over Internet Protocol (VoIP) session is more reliable if done over 3G if the user wants eventually to leave home and continue the voice over Internet Protocol (VoIP) outside, while a HTTP session is good enough on the Home WLAN). One or more of these access rules may be supported by different protocols or functions, such as OMA DM (Device Management), ANDSF (Access Network Discovery and Selection Function) in 3G/4G network, or the like, for example.

Embodiments contemplate that the granularity of the rules can also be per IP Flow, such as but not limited to policies developed by the current 3GPP MAPCON and IFOM (multi access PDN connectivity and IP flow mobility) working Group, by way of example and not limitation.

Embodiments contemplate that, by way of example and not limitation, an application may be an application running at L5 or above in an ISO module. Also by way of example, an application may be the application as seen by the user on his terminal By way of further example and not limitation, an application can be a web browser, a FTP application, a VoIP client, or a voice over Internet Protocol (VoIP) application. An application may be uniquely identified by an application ID (AID). In one or more embodiments, the OS process ID associated with the application may be used as the application ID.

Embodiments contemplate that a session may be an L4 Transport socket as opened by an application through socket API, by way of example and not limitation. Embodiments contemplate that a socket may be a UDP, a TCP, and/or a Multi-Connection Transport (e.g., MPTCP) socket. One or more embodiments contemplate that a session may be uniquely identified by a unique session ID. Embodiments contemplate that the same application may open one or multiple sessions. For example, an FTP Application may open two sessions, an FTP Control and a separate FTP Data session. In one or more embodiments, these sessions may be referred to as “dependent sessions.”

Embodiments recognize that an example task of a Connection Manager (CM) may be to make sure that a protocol stack and communication interfaces are configured as per user (and/or, perhaps to a limited extent, operator/OS/application) requirements. CMs may expect that the requirements are “direct”, which by way of example may mean that the user can specify which WiFi AP to use by choosing an SSID; the user may specify which, among several, mobile networks to use by choosing one from a menu; the application may select an interface to use by selecting a source IP—or this may be left to the operating system. Embodiments recognize that an example CM may have two roles, and perhaps only two roles: serve as an interface to the user/OS/application; and a manager for control protocols that setup connections (e.g., WiFi's WPA authentication).

One or more embodiments recognize that in evolved communication systems, such direct control by the user/OS, etc. may be undesirable or otherwise unwanted. One or more embodiments contemplate that multi-connection devices may increase, or perhaps even maximize, their utility when managed dynamically to help ensure that connection configurations—and/or even which connections may be used—are adjusted to the communication need or needs of the user and/or application, for example. Further, operator, user, device and/or application preferences are often communicated to the device via high-level policies. By way of example, and not limitation, a preference may be “use WiFi for Video when WiFi QoS is sufficient.” Embodiments recognize that current CM cannot handle such high-level policies. Further, embodiments recognize that current (or traditional) CM solutions or implementations may be insufficient to address these needs. Embodiments contemplate additions to a CM in the terminal “control plane”, for example.

Embodiments recognize that, as stated herein, a getaddrinfo( ) operation may return a list of local addresses. Embodiments also recognize algorithms that may provide for Src IP sorting, which in one or more embodiments may be based on how close the Source IP address is from a given Dest IP address, for example.

Embodiments contemplate that, perhaps in cases of a multi-homing devices, among other cases for example, static rules may not be sufficiently accurate. Indeed, existing source IP selection algorithms may base decisions on the IP addresses, and sometimes on the IP addresses only, perhaps with no other consideration about the interfaces' characteristics on which these IP addresses are mapped. Embodiments contemplate that in a multi-homing device managed by operator and/or supporting users' preferences for example, consideration such as wired/wireless, trusted/untrusted, operator preferred network, user preferred network, etc., and various other policies and/or requirements may be considered for the Source IP selection, and in one or more embodiments should be considered for the Source IP selection. Also embodiments recognize that during operation, if an application's requirements change, a CM may not address these changes dynamically. Embodiments contemplate dynamically addressing an application's changing requirements. One or more embodiments contemplate that a dynamic change may be made in response to a change of conditions that may occur after an initial configuration is made, for example. By way of example, and not limitation, embodiments contemplate that a change in network congestion may make a move of a flow from WiFi to 3G useful. Also by way of example, embodiments contemplate that a change in the number of simultaneous applications running on the WTRU may make a redistribution of how flows are allocated to various interfaces useful.

One or more embodiments contemplate a function, which may be referred to herein as a session manager (SM) for exemplary description purposes and not by limitation. For example, system and process embodiments are contemplated for SM techniques and algorithms; SM architecture and interface embodiments perhaps with one or more other functional components are contemplated; and one or more source IP address selection algorithm embodiments are contemplated.

Embodiments contemplate that the SM can be a functional component that may sit in the overall ACMS/EIPS architecture, for example. In one or more embodiments, the SM may partition the overall connection management problems into one or more less complex sub-problems. For example, for each session, the SM may decide: what kind of service(s) to be used (BW aggregation, IFOM, etc.); which radio access technologies (RATS) may be made available for a particular session; and/or what a session's priority may be with respect to other sessions. These decisions may then allow other decisions to be made in an independent fashion including, but not limited to, source IP selection, L4 protocol selection, aggregation management, among others, for example.

In one or more embodiments, the SM may be responsible for managing the one or more sockets that may be opened by the applications and/or configuring for some sockets or for each socket the full stack (Transport/IP/Physical Layers) according to the application requirements provided at the opening of the socket and/or in accordance with one or more policies in an application operating in the wireless transmit/receive unit (WTRU, or user equipment (UE)).

The SM may keep track of some or all opened sessions. The SM may update some or all opened sessions, perhaps based on information received from Application Interface (API) or from CM in case of a change in IP/Phys layers, for example. Also, the SM may provide new IP addresses, if needed, to the multi connection transport layer.

Further, embodiments contemplate that the SM may perform one or more of the following functions: session establishment, session maintenance, and/or session deletion, perhaps based on defined policies received from policy management, for example. For session establishment, the SM may request resources setup to the CM by providing the related policies and parameters, for example. Session deletion can occur either on request from the application, based on received policy or in reception of resource deletion from CM. For example, if a high priority session arrives and resources are limited, a lower priority session can be interrupted. In one or more embodiments, perhaps when a change is detected on the application (e.g., application type change, quality of service (QoS) requirements update, etc.), some QoS changes can be requested to the CM. In some embodiments, the QoS changes can be directly provided by the application, or may be detected through Packet Inspection (PI) which level may be controlled by SM.

One or more embodiments contemplate that the SM can identify when a session reconfiguration is required and may requests it to the CM. The SM can maintain session description for some or each running session. Further, the SM can perform source IP selection for the data plane. During operation, the SM may manage IP addresses exposure to multi-connection transport layer. For a MC Transport Layer (e.g., MPTCP), the SM may provide the MC transport with additional IP addresses so that the MC transport layer can negotiate with its peers additional sub-flows, for example, among other reasons. For aggregation protocols, the SM may support a scheduler control functions for the aggregated schedulers in use, for example. The SM may also interface to a security client, for example for SSO.

In one or more embodiments, the SM configuration may be provided by some pre-provisioned data, received from the user, and/or received from a network. A number of parameters may be used by the SM. They can be changed dynamically, for example through policy management functions. The SM may request the ACMS/EIPS configuration parameters to policy management by calling SM_Configuration( ). Table 1 below shows an example SM mode of operation.

TABLE 1
Example of SM Mode of Operation

| Parameters | Description |
|---|---|
| PI Level | Level of Packet Inspection applied for an application |
| BWM Mode | Type of Bandwidth Management support: |
| | to allow SM to configure the aggregation protocol |
| | to be used or not |
| IFOM Mode | Enable or disable IFOM support |
| Application QoS | Table of Application QoS requirements |
| Requirements Table | |

For some current open sessions, or for each current open session, the SM may keep and maintain some or all the related parameters in a session table such as the example SM session table shown in Table 2.

TABLE 2
Exemplary SM Session Table

| Parameters | Description | How it is provided/updated |
|---|---|---|
| SID | Session ID | Provided by ASIF (ASIF_SessionOpen call) |
| | | Do not changed during operation |
| PNAME | Application Name | The initial value is provided by ASIF |
| | | (ASIF_SessionConnect) and can be updated during |
| | | operation with ASIF_SessionUpdate |
| AID | Application ID | Set to NULL by default. If no NULL, this means |
| | | that the session is a sub-flow of an application. It |
| | | should preferably be set to the Process ID assigned |
| | | by the OS. It can be updated during operation by |
| | | ASIF (ASIF_SessionUpdate) |
| QoS | QoS expected for this | Provided by ASIF (ASIF_SessionOpen call) or can |
| | session | be updated based on updated PNAME |

ASIF related parameters

| | |
|---|---|
| PI Level | Internal value, set to 0 (“None”) by default. Can be |
| | updated by SM during operation |

Transport FC related parameters

| | | |
|---|---|---|
| TrFC_ID | Transport ID | Provided by TrFC as output of TrFC_socket( ). |
| | | Do not changed during operation |
| Domain | | Provided by ASIF (ASIF_SessionOpen call) |
| | | Do not changed during operation |
| Type | SOCK_DGRAM, | Provided by ASIF (ASIF_SessionOpen call) |
| | SOCK_RAW, | Do not changed during operation |
| | SOCK_SEQPACKET, | |
| | and SOCK_STREAM. | |
| Protocol | | Provided by ASIF (ASIF_SessionOpen call) |
| | | Can changed per SM decision during TsFC |
| | | selection |
| MC Protocol | NULL, MPTCP | Internal to SM, set by SM during TsFC selection |
| MC List of | | In case of MC TrFC, list of Src IP used by this |
| Src IP | | TrFC |
| | | Updated by TrFC (SM_MC_Update) |

In one or more embodiments, the SM may receive connection information from the CM. Example connection related information is shown in Table 3.

TABLE 3
Exemplary Connection related information

| | | |
|---|---|---|
| Parameters | Description | How it is provided/updated |

IP Stack related parameters

| | | |
|---|---|---|
| IP Flow Id | (5-tuple, 6-tuple) | Note: for MC Connection, the 5-ttuple is the one |
| | | received by the Application but does not reflect the |
| | | effective 5-tuples used by MC Transport |
| List of Src IP | IP type: | List of Source IP address(es) in use by the session. |
| addresses | 1-local IP address | Initially provided by CM as output of CM_Connect |
| | (non-3GPP untrusted | and updated by CM during operation by |
| | only), | |
| | 2-tunnel IP address | |
| | (non-3GPP untrusted | |
| | only), | |
| | 3-3G IP | |
| LIF instance | 0 (for no LIF/ | Type of LIF used for this session |
| | PASS_THROUGH) | If LIF instance is set to 1, a second RAT can be |
| | 1 (only 1 instance | open later to enable IFOM |
| | supported for now). | |
| VIF type | None | Setup by SM during IP Stack Selection and |
| | (PASS_THROUGH), | requested to CM |
| | IPsec | |

CM related parameters

| | | |
|---|---|---|
| CID | Connection ID | Provided by CM as output of CM_Connect. |
| | | Do not changed during operation |

One or more embodiments contemplate that, while some sessions or each session may have its own Session Table, SM may also store common resources that may be available on the WTRU and which may be shared between the different sessions. Examples of such parameters (or resources) may be stored in an SM Operation Table, an example of which is illustrated in Table 4.

TABLE 4
Exemplary SM Operation Table

| Parameters | Description |
|---|---|
| Session Number | Total number of current open sessions. |
| | Updated at every opening and closing sessions. |
| Application | Total number of active application. |
| Number | If each session is independent of the others, |
| | Application Number equals Session Number. When |
| | separate sessions are “glued” together |
| | (i.e. are identified as belonging to the same |
| | application identified by an AID), Application |
| | Number is lower than Session Number. Updated by |
| | ASIF with SM_SessionUpdate( ) with a AID |
| List of PhIF | List of current PhIF up. |
| | Updated by CM with SM_PhIFStatus( ) |
| List of WiFi SSID | List of current SSIDs with their signal strength. |
| Signal Strenght | Updated by CM with SM_WiFiAPList( ) |
| List of Src IP | Dynamic list of IP addresses setup and available |
| available | on the platform Updated by TrFC with |
| | SM_PhIFStatus([in] PhIF, |
| | [in] status (UP, DOWN)) |

One or more embodiments contemplate that, perhaps prior to requesting resources to CM, the SM may check the application's requirements and the policies that may apply to the requested socket to identify an appropriate or most suitable match.

Embodiments contemplate the application of Quality of Service (QoS) requirements. Example QoS priorities include throughput, latency, error, etc. An example network for the application includes APN provided for a 3G network, and network ID provided for non-3GPP access. A list of prohibited networks may be provided. Traffic prioritization may be provided. Mobility requirements per application may be provided. BWA (e.g., aggregation) requirements may be provided. Embodiments contemplate that security requirements may be provided. Embodiments contemplate that BWA may be conducted via one or more mechanisms involved in deciding which actual interface an IP Flow may be sent over. Embodiments contemplate that the process of sending IP Flow may involve, among other things, a segregation (e.g., the ability to assign flows to interfaces on a per-flow basis). One or more embodiments contemplate that BWA may also include support of Flow Mobility (e.g., the ability to move flows between interfaces. Further, one or more embodiments contemplate that BWA may include aggregation (e.g., the ability to send a single flow over multiple interfaces at the same time).

Embodiments contemplate that for LEGACY applications, the QoS requirements may be provided by the policy management. Table 5 below shows an example of per application QoS requirements.

TABLE 5
Example of per Application QoS Requirements Table

| Application | | | Mobility | Access Network |
|---|---|---|---|---|
| Protocol | Application Protocol | QoS Policy | Policies | Policies |
| NULL | Unknown | Low | No | Should be offloaded to |
| | | bandwidth | | WLAN/SSIDxx |
| | | | | whenever possible |
| HTTP | HTTP | Medium | No | Should be offloaded to |
| | | bandwidth | | WLAN/SSIDyy |
| | | | | whenever possible |
| | HTTP_DOWNLOAD | Low to | Yes | Should be offloaded to |
| | | Medium | | WLAN/SSIDyy |
| | | bandwidth | | whenever possible |
| | HTTP_AUDIO | High | Yes | Should be offloaded to |
| | | bandwidth | | WLAN/SSIDyy |
| | | | | whenever possible |
| | HTTP_VIDEO | High | Yes | Should be offloaded to |
| | | bandwidth | | WLAN/SSIDyy |
| | | | | whenever possible |
| | HTTP_PLAIN | Medium | No | Should be offloaded to |
| | | bandwidth | | WLAN/SSIDyy |
| | | | | whenever possible |
| FTP | FTP_CTRL | Low | Yes | Should stay in 3GPP |
| | | bandwidth | | network |
| | | Security | | Offload to WLAN not |
| | | | | allowed |
| | FTP_DATA | Medium to | Yes | Should stay in 3GPP |
| | | High | | network |
| | | bandwidth | | Offload to WLAN not |
| | | Security | | allowed |
| SIP | SIP | Low | Yes | Should stay in 3GPP |
| | | bandwidth | | network |
| | | Security | | Offload to WLAN not |
| | | | | allowed |

One or more embodiments contemplate that for ADVANCED applications, these QoS requirements may be provided directly by the application with the ADV socket( ) call, for example.

Embodiments contemplate one or more IFOM Type Policies. While the initial IFOM support is network-controlled IFOM (e.g., the WTRU may be passive and may react to network decisions by sending outcoming packets on interface on which it has received incoming packets), the WTRU may need to setup or not the LIF for a requested socket. For this, the policies are two-fold, per flow based and per services based rules, similarly to the Inter System Routing Policies (ISRP) element including in ANDSF Management Object, allowing the operator to provide policies based on the traffic exchanged by the user equipment (UE) or WTRU. The granularity of the policies is the IP flow. In this way, the operator can indicate different preferred or forbidden radio access technologies as a function of the type of traffic the WTRU may send.

The IP flows may be identified by the range on which the 5-tuplets belong (e.g., protocol type, start/end of source and destination IP address and start/end of source and destination ports). The service may be identified by the APN (Access Point Name). As an example, this can be a set of ISRP provided by an operator to the WTRU. Table 6 shows an example of per flow policies (note that information included in the ANDSF MO such as validity, location and others are not shown in this table for the sake of simplicity).

TABLE 6
Example of Per Flow Policies Table

| | Rule | | Forbidden |
|---|---|---|---|
| Traffic description | Priority | Preferred RATs | RATs |
| dest_port == 2568 | 2 | 1) 3GPP | 1) WLAN |
| dest_addr == | 1 | 1) WLAN with IFOM | |
| 74.225.124.0/24 | | 2) 3GPP | |
| dest_port == 80 | 5 | 1) Non seamless | |
| | | WLAN | |
| | | 2) 3GPP | |
| APN == “internet” | 3 | 1) WLAN with IFOM | |
| | | 2) 3GPP | |
| APN == “internet” && | 2 | 1) 3GPP | 1) WLAN |
| dest_port == 7654 | | | |

Embodiments contemplate a SM_SessionOpen operation. This operation may be used to establish a new session, identified by the session ID received through the SM_SessionOpen( ) call. At that stage, the SM may create a new session table for this session, as shown in Table 2, and may store the SessionID and the transport FC related parameters received on the SM_SessionOpen( ).

Embodiments contemplate an SM_SessionConnect operation. In one or more embodiments, the SM may store in the session table the parameters received on the SM_Connect( ) call for the session identified by the Session ID, e.g., the application protocol (PNAME) and the requested QoS (if available). The SM may also update the destination part of the IP flow ID (5-tuple, 6-tuple) with the destination address with its length (IPv4 or IPv6) also received in the SM_SessionConnect( ). Based on this input, in one or more embodiments—perhaps additionally to the policies that apply to the WTRU—the SM may setup the full stack for this session, e.g., define the transport layer and physical layer resources and requests their setup to the TrFC and to CM.

By way of example, and not limitation, the following are some examples of the type of SM_SessionConnect( ) scenarios. In one or more embodiments, the application may use a WiFi breakout but can send data over 3GPP. In such cases, the following may be applied: List Phys (WiFi, 3GPP); LIF=0; and/or VIF=0, for example.

In one or more embodiments, the application may use a LIF over WiFi and 3GPP. In such cases, the following may be applied: List Phys (WiFi, 3GPP); LIF=1; and/or VIF=IPsec, for example.

In one or more embodiments, the application may want to do some aggregation over WiFi and 3GPP. In such cases, the following may be applied: List Phys (WiFi, 3GPP); LIF=0; and/or VIF=0, for example.

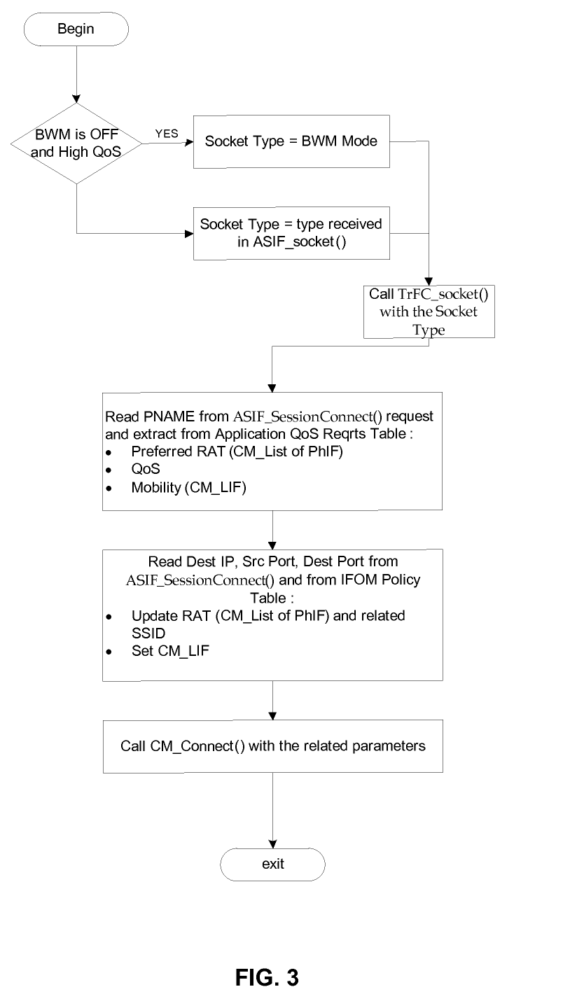

FIG. 3 illustrates a flow chart of an example SM connection establishment process in accordance with contemplated embodiments.

Embodiments contemplate Transport Layer Selection. To setup correctly the stack, one or more embodiments contemplate that the SM may decide which transport session should be open or, in some embodiments, may needs to be open. The SM may request the same type of socket as the one requested in the in the socket( ) request received from an Advanced Socket Interface (ASIF), perhaps for example if the BWM mode of operation is set to OFF, among other reasons for example. In one or more embodiments, if the type of socket is SOCK_STREAM (which may be considered as a TCP session) and/or if the internal configuration parameter BWM status is different to OFF, then perhaps for those conditions and/or other conditions, the SM may request a multi connection transport layer according the BWM mode. The SM may update accordingly the MC protocol in the session table. In one or more embodiments, the BWM status/mode may be equivalent to an L4 multi-path management status/mode, for example, which may indicate and/or activate the use of MPTCP or similar protocols.

Embodiments contemplate Mobility Type and IFOM Selection. For the purpose of, for example (among other purposes), setting up a correct physical interface (PhIF) and/or requesting the appropriate IP type (e.g., local IP address or a tunnel IP address), the SM may check the PNAME and the IP flow ID (5-tuple) requested. Based on one or more of them, the SM may extract the mobility policies for the application QoS requirement table and/or the flow policies from the per flow policies table. This may allow the SM to decide the PhIF (with the related network name, e.g., SSID for WiFi), the LIF type, and/or the VIF type, for example.

Embodiments contemplate an SM_SessionClose function/operation. This operation may close the session identified by the session ID received through the SIF_SessionClose( ) or ASIF_ProtocolViolationNotification( ) call. SM_Session Close may release the related Phys and transport resources by calling TrFC_Disconnect and CM connection with CM_Disconnect, for example. In one or more embodiments, SM_SessionClose may then delete the SessionTable related to this Session ID.

Embodiments contemplate an SM_OperationTableUpdate function/operation. This function may update the SM operation table based on, at least in part, input received from the CM. The function may update the list of interfaces available received through the SM_PhIFStatus( ) call and/or may update the list of Src IP available received through the different CM_connect( ) for example.

Embodiments contemplate an SM_BWM function/operation (BandWidth Management). In one or more embodiments, perhaps when the sessions are created for example, the SM may maintain and/or monitor them during operation. In sessions that may support a MC TransportFC (e.g., MC protocol set to MPTCP in a session table), the SM may provide them with any new (source) IP addresses so that the MC transport session can open or close one or more related sub-flows with its MPTCP peer, for example. Embodiments contemplate that the SM_BWM (BandWidth Management) function may provide the aforementioned functionality. For example, perhaps when a new PhIF is indicated as UP or DW, among other reasons, the SM may decide if an IP can be retrieved from this interface and provided to the MC TrFC.

Embodiments contemplate an SM PolicyUpdate function/operation. In one or more embodiments, perhaps during operation for example, the policies can dynamically change. For example, if a new or recent (e.g., a change of conditions after an initial configuration is made) BWM Mode or IFOM are received, among other reasons, the SM may close and/or open one or more sessions which do not address the recently received BWM and/or IFOM policies by calling the SM_SessionClose function with the relevant Session ID.

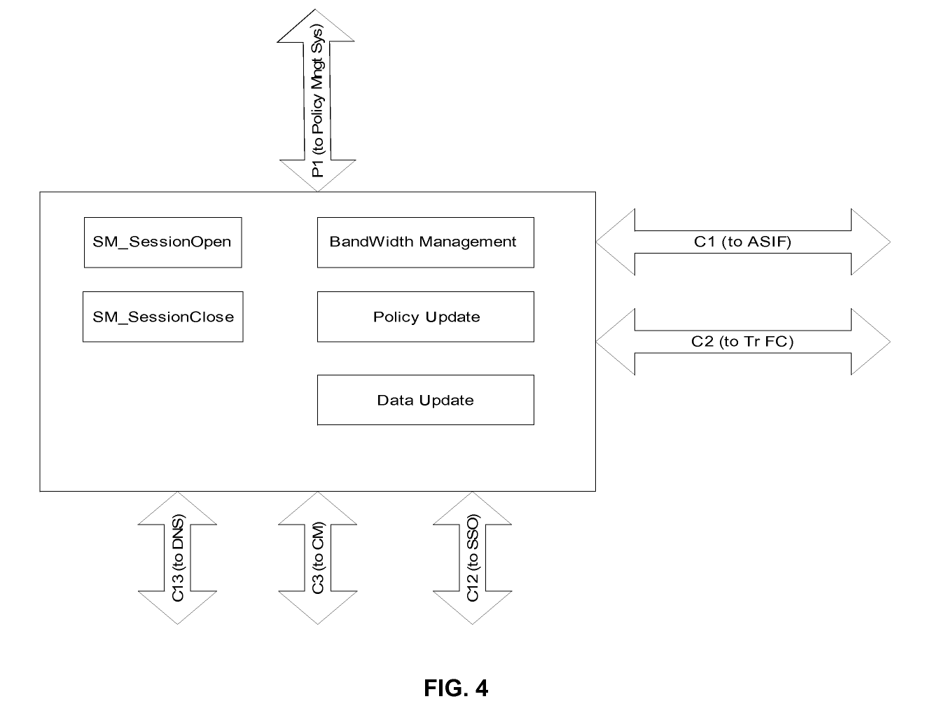

Embodiments contemplate Session Manager Architecture & Interfaces. In one or more embodiments, the SM may interface with the CM, policy management system, ASIF, transport FC, SSO proxy, and/or DNS proxy through, respectively, interfaces C3, P1, C1, C2, C12 and/or C13. FIG. 4 illustrates a functional diagram of an example SM FC.

Embodiments contemplate one or more Session Manager (SM) Interfaces. For example, one or more embodiments contemplate a C1—Session Manager and ASIF interface. C1 may serve as the interface between the advanced socket IF (ASIF) and the session manager (SM). This interface may allow the ASIF to notify the SM that a new session has been detected or that a change has occurred for an active session. By way of example, and not limitation, a change can be an addition of a new sub-flow to the session, a deletion of a sub-flow or a change in the session description (new QoS, mobility required or not, level of security), among other changes. Example C1 functions are provided in Table 7.

TABLE 7
Exemplary C1 Functions

| Function Name | Parameters | Description |
|---|---|---|
| SM_SessionOpen( ) | [in] domain | Called by ASIF to notify SM that a new |
| | [in] type | session is detected. ASIF provided the |
| | [in] protocol | parameters received on the socket( ) call, |
| | [in] SessionID | and the allocated Session ID. The [adv] |
| | [in] adv | values are passed to SM even if the |
| | | application does not use the [adv] expended |
| | | values in the socket call. The ASIF fills in |
| | | information it can imply from socket call, |
| | | etc., otherwise it fills in NULL for each |
| | | value. |
| SM_SessionConnect( ) | [in] Session ID | Called by ASIF to notify SM that |
| | [in] PNAME | connection is requested on a previously |
| | [in] Dest | open session. ASIF provided the related |
| | Address | Session ID, the PNAME, and the |
| | [in] Length of | parameters received in the connect( ). |
| | Dest Addr (IPv4 | The related QoS may or may not be |
| | or IPv6) | available |
| | [in] QoS | |
| SM_SessionUpdate( ) | [in] Session ID | Called by ASIF to notify SM any update on |
| | [in] PNAME | the session identified by Session ID. |
| | [in] AID | ASIF can provide an Application Protocol |
| | | update or AID if the session is identified as |
| | | a sub-flow |
| ASIF_PiLevelConfiguration( ) | [in] Level | Called by SM to configure the inspection |
| | [in] Session ID | level of PI performed on a session identified |
| | | by a SID transmitted with the function. |
| | | If SID set to ALL_SESSION, the PI's level |
| | | is the same for all the open sessions. |
| SM_ProtocolViolationNotification( ) | [in] Session ID | Called by ASIF to notify a violation in the |
| | | application protocol |
| SM_SessionClose( ) | [in] SessionID | Called by ASIF to notify SM to close the |
| | | session identified by “Session ID” |
| getnameinfo( ) | | Function transmitted directly by ASIF from |
| | | the application to SM. |
| | | It returns a list of addresses to the |
| | | application. This list might contain both |
| | | IPv6 and IPv4 addresses. |

Embodiments contemplate a C2 interface, perhaps to sever for the Session Manager and Transport FC (TFC), for example. Table 8 shows example C2 functions.

TABLE 8
Exemplary C2 Functions

| Function Name | Parameters | Description |
|---|---|---|
| TrFC_socket( ) | [in] domain | Called by SM used to create a new |
| | [in] type | Transport socket in the Transport FC |
| | [in] protocol | Type is UDP, TCP, or MPTCP |
| | [out] TrFC_ID | TrFC returns a TrFC_ID used for future |
| | | operation on these Transport Socket |
| TrFC_connect( ) | [in] TrFC_ID | Called by SM to make a connection on a |
| | [in] Dest Address | connection-mode socket or to set or reset |
| | [in] Length of Dest | the peer address of a connectionless-mode |
| | Addr (IPv4 or IPv6) | socket. |
| | [out] return value | |
| TrFC_IP_Update | [in] TrFC_ID | Called by SM to inform the Multi- |
| | [in] IP address | Connection (MPTCP) Transport |
| | [in] operation (add, | Connection that a IP address is available or |
| | delete) | not for bandwidth aggregation |
| SM_MC_Update | [in] TrFC_ID | Called by TrFC to inform SM about the |
| | [in] IP address | number of IP used by a MC Connection |
| | [in] operation (add, | identified by TrFC_ID |
| | delete) | |
| TrFC_Disconnect | [in] TrFC_ID | Called by SM to notify TrFC to disconnect |
| | | the connection identified by TrFC_ID |
| Policies from PM | | |
| through SM? | | |

Embodiments contemplate a C3 interface, perhaps to serve for the Connection Manager (CM) and Session Manager (SM), for example. In one or more embodiments, C3 is the interface between the CM and the SM. Example C3 functions are provided in Table 9.

TABLE 9
Exemplary C3 Functions

| Function Name | Parameters | Description |
|---|---|---|
| CM_Connect | [in] request type | Called by SM to request CM to setup |
| | [in] list of PhIF | an IP session. |
| | [in] SSID | Request type is: 1 - connect to all |
| | [in] LIF instance | PhIFs specified in the list, 2 - |
| | [in] VIF type | connect to only 1 PhIF starting |
| | [out] status | with the most preferred and going |
| | [out] list (IP address | through the list if the first one fails |
| | obtained, IP type, PhIF, | to connect |
| | SSID, connectionID) | The list of PhIF on which a |
| | | connection should be established |
| | | in the preferred order. |
| | | WiFi SSID has a meaning only if |
| | | PhIF is WiFi. It specifies to which |
| | | AP the association shall be done. |
| | | SSID_ANY may be specified if no |
| | | specific SSID is desired |
| | | Whether the connections should |
| | | be associated to a LIF should be |
| | | specified. LIF instance is a |
| | | number identifying a LIF instance: |
| | | 0 (for no LIF/ |
| | | PASS_THROUGH) |
| | | VIF type is specifying which type |
| | | of tunnel should be established. |
| | | Possible values are, e.g.: none |
| | | (PASS_THROUGH), IPsec. |
| | | A status indicating if the operation |
| | | was successful, partially |
| | | successful or failed. |
| | | The IP address allocated for that |
| | | connection is returned, if the |
| | | status is successful. |
| | | IP type: 1 - local IP address (non- |
| | | 3GPP untrusted), 2 - tunnel IP |
| | | address (non-3GPP untrusted), 3 - |
| | | 3G |
| | | The connectionID should be used |
| | | for further references to this |
| | | connection (e.g. for disconnection |
| CM_Disconnect | [in] connectionID | Called by SM to request the |
| | [out] status | disconnection of a previously opened |
| | | IP connection |
| CM_Config | [in] measurements | Called by the SM. |
| | indication interval | CM may be configured to send |
| | [in] PhIF status indications | measurement indications at pre- |
| | enabled/disabled | determined intervals (0 disables |
| | [out] status | indications). |
| | | PhIF status indications (sent by CM to |
| | | SM) may be enabled/disabled |
| CM_GetMeasurements | [in] PhIF | SM may query the CM to get the |
| | [out] measurements | measurements specific to a PhIF. |
| SM_PhIFStatusInd | [in] PhIF | Called by CM to inform SM of any |
| | [in] status (UP, DOWN) | changes in the PhIF status. Function |
| | | provided by SM. |
| SM_WiFiAPListInd | [in] list of SSIDs with | CM calls this function provided by |
| | their signal strength | SM when WiFi APs are detected. |
| SM_MeasurementsInd | [in] PhIF | CM calls this function to send |
| | [in] measurements | collected measurements to SM using |
| | | indications (indications interval |
| | | previously configured by SM). |
| | | Function provided by SM. |
| SM_FlowMovementInd | [in] flow identifier (5- | Function provided by the SM and |
| | tuple) | called by the CM when a flow is |
| | [in] from interface | redirected to a new interface (network |
| | [in] to interface | controlled) |

Embodiments contemplate a P1 interface, perhaps to serve for the Policy Manager and Session Manager (SM), for example. In one or more embodiments, P1 may allow policy manager to provide SM with the policy that may need to be applied by the device or may be used by the device. Table 10 below shows example P1 functions.

TABLE 10
Exemplary P1 Functions

| Function Name | Parameters | Description |
|---|---|---|
| SM_Configuration | [out] BWM Mode | Called by SM to request its modes of |
| | MPTCP | operation. |
| | OTHER | If BWM is OFF, SM cannot request |
| | OFF | any MC Transport FC socket. |
| | [out] IFOM Mode | |
| | (ON/OFF) | |
| SM_ConfigurationUpdate | [in] BWM Mode | Called by PM to update SM modes of |
| | [in] IFOM Mode | operation. BWM Mode and IFOM |
| | | Mode are similar to the ones in |
| | | SM_Configuration |
| SM_PolicyConfig | [out] Flow Based Policy | Called by SM to request For Flow and |
| | [out] Service Based Policy | For Service policies |
| SM_PolicyUpdate | [in] Flow Based Policy | Called by PM to provide SM with any |
| | [in] Service Based Policy | update policy during operation |

Embodiments contemplate a C12 interface, perhaps to serve as an interface for the Session Manager and SSO Proxy, for example. In one or more embodiments, C12 may be the interface between the SM and the SSO proxy. This interface may allow the triggering of the SSO steps that handle authentication of the user in the network, for example. Example C12 functions are provided in Table 11.

TABLE 11
Exemplary C12 Functions

| Function Name | Parameters | Description |
|---|---|---|
| SSO_Trigger | [out] status | Called by SM to trigger |
| | [out] any learned information | SSO operations. |
| | required to establish a | A status indicating if the |
| | connection (e.g. keys) | SSO completed |
| | | successfully is returned |

Embodiments contemplate a C13 interface, perhaps to serve the Session Manager (SM) and Domain Name System (DNS), for example. In one or more embodiments, C12 may be the interface between the SM and the DNS proxy. Table 12 shows example C13 functions.

TABLE 12
Exemplary C13 Functions

| Function Name | Parameters | Description |
|---|---|---|
| DNS_Trigger | [out] status | Called by SM to trigger DNS |
| | | operations. |
| | [out] IP address | A status indicating if the DNS |
| | | completed successfully is returned |

Embodiments contemplate one or more Source IP Address Selection Algorithms. In one or more embodiments, heretofore unknown or described functions and/or operations of the parameter “Getaddrinfo” are contemplated. In one or more embodiments, the SM may perform source IP address selection that may better align with the applied policies, e.g., a specific application can go over this type of link, based on QoS, security, etc.

In one or more embodiments, the CM may indicate to SM the mobility support of an IP address (if it is a Mobile Core IP address, or a local breakout IP, etc.). The SM may have the list of source IP available stored in the SM operation table. The SM may maintain a table of initial source IP and conditions when they are used. Example conditions and source IP that may be used are illustrated in Table 12-A.

TABLE 12-A
Exemplary conditions and Source IP

| Conditions | Source IP to be used |
|---|---|
| Video application & wifi present | IPx |
| Video application & wifi off | IPy |
| . . . | . . . |

Embodiments contemplate that, for cases not specified in table 12-A (and perhaps in all such cases), the SM may use a DEFAULT_SOURCE_IP. DEFAULT_SOURCEIP may be determined based on, at least in part, operator and other policies. In one or more embodiments, the DEFAULT_SOURCE_IP may be at least one of following: primary mobile operation IP associated with primary PDP context; and/or “fake” non-existent IP from private network, e.g. 192.xxx.xxx.xxx.

Embodiments contemplate one or more Local IP Addresses for an Unbound Socket. In one or more embodiments, perhaps if the connect( ) is called to an unbound socket for example (among other reasons and conditions), the kernel may determine over which local interface to send outgoing packets. In one or more embodiments, the kernel may select a random free source port with the local address set to INADDR_ANY, which may mean the default IP address provided by the routing table. Similarly to source IP selection, in one or more embodiments, the SM may perform this function to better align with the policies, e.g., most preferred network, etc.

Embodiments contemplate one or more SM Policies and QoS Requirements. In one or more embodiments, perhaps prior to requesting resources to CM—or for other reasons or conditions, the SM may check the application's requirements and the policies that apply to the requested socket to identify the best match, for example.

Embodiments contemplate one or more Application QoS Requirements. By way of example, and not limitation, QoS requirements may include, but are not limited to, QoS priorities (e.g., throughput, latency, error, etc.); preferred network for the application (e.g., preferred APN provided for 3G network, and preferred network ID provided for non-3GPP access); list of prohibited networks; traffic prioritization; mobility requirement per application; BWA (i.e. aggregation) requirement; and/or security requirements.

For LEGACY Application, the QoS requirements may be provided by the policy management (policy and/or QoS manager), with a table similar to the following Table 13 showing an example of per application QoS requirements.

TABLE 13
Example of per Application QoS Requirements Table

| Application | | | Mobility | Access Network |
|---|---|---|---|---|
| Protocol | Application Protocol | QoS Policy | Policies | Policies |
| NULL | Unknown | Low | No | Should be offloaded to |
| | | bandwidth | | WLAN/SSIDxx |
| | | | | whenever possible |
| HTTP | HTTP | Medium | No | Should be offloaded to |
| | | bandwidth | | WLAN/SSIDyy |
| | | | | whenever possible |
| | HTTP_DOWNLOAD | Low to | Yes | Should be offloaded to |
| | | Medium | | WLAN/SSIDyy |
| | | bandwidth | | whenever possible |
| | HTTP_AUDIO | High | Yes | Should be offloaded to |
| | | bandwidth | | WLAN/SSIDyy |
| | | | | whenever possible |
| | HTTP_VIDEO | High | Yes | Should be offloaded to |
| | | bandwidth | | WLAN/SSIDyy |
| | | | | whenever possible |
| | HTTP_PLAIN | Medium | No | Should be offloaded to |
| | | bandwidth | | WLAN/SSIDyy |
| | | | | whenever possible |
| FTP | FTP_CTRL | Low | Yes | Should stay in 3GPP |
| | | bandwidth | | network |
| | | Security | | Offload to WLAN not |
| | | | | allowed |
| | FTP_DATA | Medium to | Yes | Should stay in 3GPP |
| | | High | | network |
| | | bandwidth | | Offload to WLAN not |
| | | Security | | allowed |
| SIP | SIP | Low | Yes | Should stay in 3GPP |
| | | bandwidth | | network |
| | | Security | | Offload to WLAN not |
| | | | | allowed |

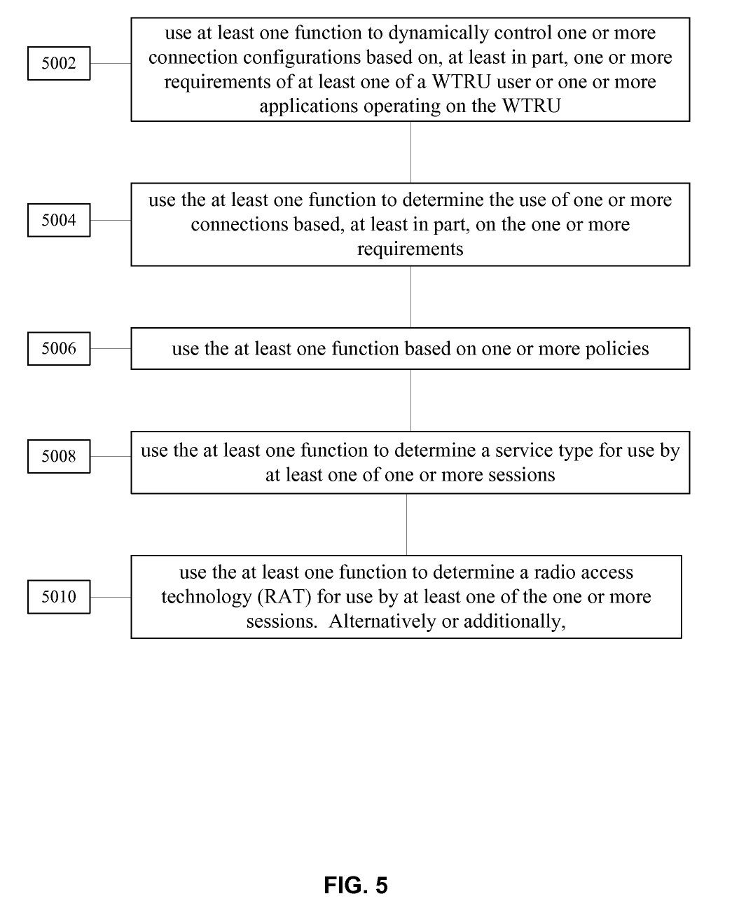

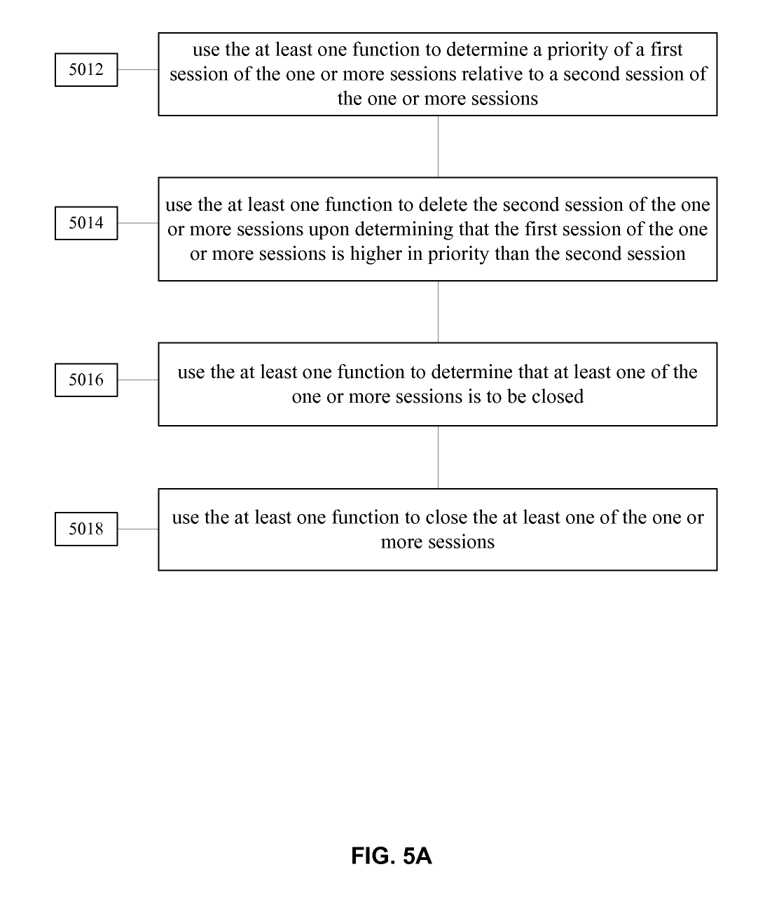

In view of FIGS. 1-4 and the aforementioned description, and referring to FIG. 5, embodiments contemplate a wireless transmit/receive unit (WTRU) that may comprise a processor. At 5002, the processor may be configured, at least in part, to use at least one function to dynamically control one or more connection configurations based on, at least in part, one or more requirements of at least one of a WTRU user or one or more applications operating on the WTRU. Embodiments further contemplate that alternatively or additionally, at 5004, the processor may be further configured to use the at least one function to determine the use of one or more connections based, at least in part, on the one or more requirements. One or more embodiments contemplate that the one or more connections may be part of one or more respective sessions. At 5006, embodiments contemplate that, alternatively or additionally, the processor may be further configured to use the at least one function based on one or more policies. One or more embodiments contemplate that the at least one function may operate in a control plane of the WTRU. Also, one or more embodiments contemplate that the at least one function may be a first function, and the first function may include one or more second functions.

Embodiments contemplate that, alternatively or additionally, at 5008, the processor may be further configured to use the at least one function to determine a service type for use by at least one of the one or more sessions. At, 5010, alternatively or additionally, embodiments contemplate that the processor may be further configured to use the at least one function to determine a radio access technology (RAT) for use by at least one of the one or more sessions. Referring to FIG. 5A, alternatively or additionally, at 5012, embodiments contemplate that the processor may be further configured to use the at least one function to determine a priority of a first session of the one or more sessions relative to a second session of the one or more sessions.

At 5014, alternatively or additionally, embodiments contemplate that the processor may be further configured to use the at least one function to delete the second session of the one or more sessions upon determining that the first session of the one or more sessions is higher in priority than the second session. One or more embodiments contemplate that the at least one function may be a session manager function. Alternatively or additionally, at 5016, embodiments contemplate that the processor may be configured to use the at least one function to determine that at least one of the one or more sessions is to be closed, and, at 5018, to use the at least one function to close the at least one of the one or more sessions.

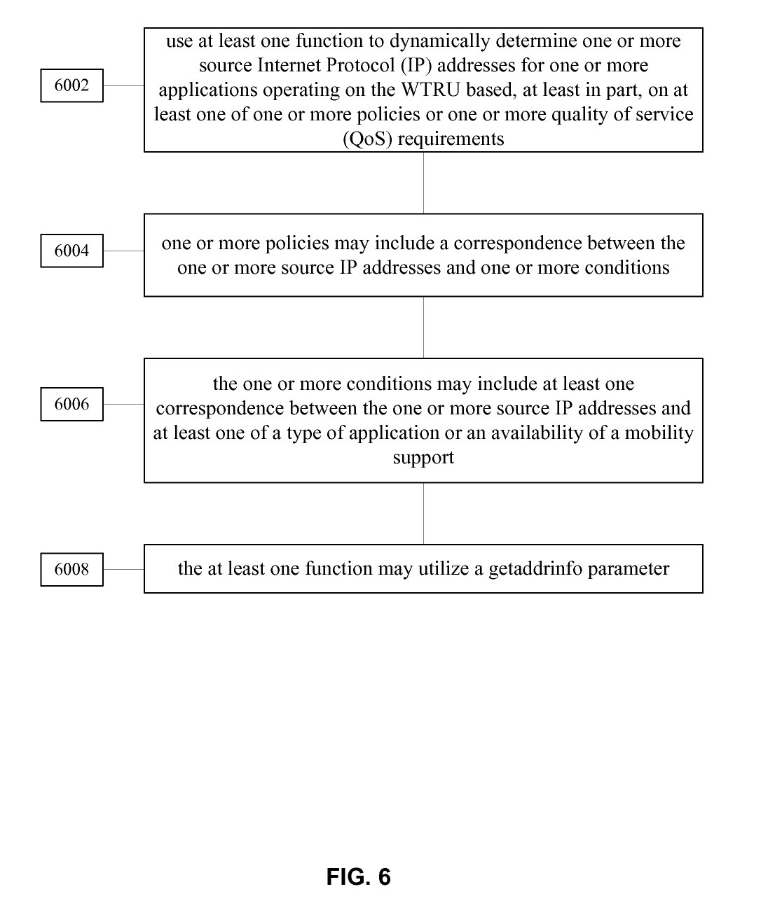

Referring to FIG. 6, embodiments further contemplate a wireless transmit/receive unit (WTRU) that may comprise a processor. At 6002, embodiments contemplate that the processor may be configured, at least in part, to use at least one function to dynamically determine one or more source Internet Protocol (IP) addresses for one or more applications operating on the WTRU based, at least in part, on at least one of one or more policies or one or more quality of service (QoS) requirements. Alternatively or additionally, at 6004, one or more embodiments contemplate that the one or more policies may include a correspondence between the one or more source IP addresses and one or more conditions.

At 6006, alternatively or additionally, embodiments contemplate that the one or more conditions may include at least one correspondence between the one or more source IP addresses and at least one of a type of application or an availability of a mobility support. One or more embodiments contemplate that the at least one function may be a session manager function. At 6008, alternatively or additionally, embodiments contemplate that the at least one function may utilize a getaddrinfo parameter. Embodiments contemplate that the QoS requirements may include at least one of a preferred network for an application, a list of prohibited networks, a mobility requirement per application, or a bandwidth aggregation requirement.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU), the WTRU comprising:
a processor, the processor configured, at least in part, to use at least one function to dynamically control one or more connection configurations based, at least in part, on one or more requirements of at least one of a WTRU user or one or more applications operating on the WTRU.

2. The WTRU of claim 1, wherein the processor is further configured to use the at least one function to determine the use of one or more connections based, at least in part, on the one or more requirements.

3. The WTRU of claim 2, wherein the one or more connections are part of one or more respective sessions.

4. The WTRU of claim 2, wherein the processor is further configured to use the at least one function based on one or more policies.

5. The WTRU of claim 2, wherein the at least one function operates in a control plane of the WTRU.

6. The WTRU of claim 3, wherein the at least one function is a first function, and the first function includes one or more second functions.

7. The WTRU of claim 3, wherein the processor is further configured to use the at least one function to determine a service type for use by at least one of the one or more sessions.

8. The WTRU of claim 3, wherein the processor is further configured to use the at least one function to determine a radio access technology (RAT) for use by at least one of the one or more sessions.

9. The WTRU of claim 3, wherein the processor is further configured to use the at least one function to determine a priority of a first session of the one or more sessions relative to a second session of the one or more sessions.

10. The WTRU of claim 1, the at least one function is a session manager function.

11. A wireless transmit/receive unit (WTRU), the WTRU comprising:
a processor, the processor configured, at least in part, to use at least one function to dynamically determine one or more source Internet Protocol (IP) addresses for one or more applications operating on the WTRU based, at least in part, on at least one of one or more policies or one or more quality of service (QoS) requirements.

12. The WTRU of claim 11, wherein the one or more policies include a correspondence between the one or more source IP addresses and one or more conditions.

13. The WTRU of claim 12, wherein the one or more conditions includes at least one correspondence between the one or more source IP addresses and at least one of a type of application or an availability of a mobility support.

14. The WTRU of claim 11, wherein the at least one function is a session manager function.

15. The WTRU of claim 11, wherein the at least one function utilizes a getaddrinfo parameter.

16. The WTRU of claim 11, wherein the QoS requirements include at least one of a preferred network for an application, a list of prohibited networks, a mobility requirement per application, or a bandwidth aggregation requirement.

17. A method implemented by a wireless transmit/receive unit (WTRU), the method comprising:
using at least one function to dynamically control one or more connection configurations based on, at least in part, one or more requirements of at least one of a WTRU user or one or more applications operating on the WTRU; and
using the at least one function to determine the use of one or more connections based, at least in part, on the one or more requirements, the one or more connections being part of one or more respective sessions.

18. The method of claim 17, further comprising using the at least one function to:
determine that at least one of the one or more sessions is to be closed; and
close the at least one of the one or more sessions.

19. The method of claim 17, further comprising using the at least one function to determine a radio access technology (RAT) for use by at least one of the one or more sessions.

20. The method of claim 17, further comprising using the at least one function to:
determine a priority of a first session of the one or more sessions relative to a second session of the one or more sessions; and
delete the second session of the one or more sessions upon determining that the first session of the one or more sessions is higher in priority than the second session.
